(19) United States
(12) Patent Application Publication
(10) Pub. No.: US 2009/0132549 A1
(43) Pub. Date: May 21, 2009

(54) Host for data broadcast and a method of processing data for data broadcast

(75) Inventors: Hak Joo Lee, Seoul (KR); Sung Min Lee, Seoul (KR)

Correspondence Address: MCKENNA LONG & ALDRIDGE LLP, 1900 K STREET, NW, WASHINGTON, DC, 20006, US

(73) Assignee: LG ELECTRONICS INC., Yeongdeungpo-gu (KR)

(21) Appl. No.: 12/289,347

(22) Filed: Oct. 24, 2008

(30) Foreign Application Priority Data
Oct. 25, 2007 (KR) 10-2007-0107907

(51) Int. Cl. G06F 17/30

(52) U.S. Cl. 707/10; 725/86; 707/E17.001

(57) ABSTRACT

A host for data broadcasting includes a host controller configured to receive a request for searching a remote storage device connected to the host using a network from an application, control to call a method and detect the remote storage device in accordance with the received request, generate an event for returning a result of the detection according to the called method to the application, and return the generated event to the application.

This application claims the benefit of the Korean Patent Application No. 10-2007-0107907, filed on Oct. 25, 2007, which is hereby incorporated by reference as if fully set forth herein.

### BACKGROUND OF THE INVENTION

1. Field of the Invention

The present invention relates to a host for data broadcast and a method of processing data for data broadcast, and more particularly, to communicate a data for data broadcast between the host and an application.

2. Discussion of the Related Art

Currently, digital broadcasting is performed via various media. In this case, the media include terrestrial, cable, satellite, internet protocol (IP) and the like. In the following description, assume that the digital broadcasting is performed via the cable for example.

A general cable broadcasting system mainly consists of a transmitting part and a receiving part. The transmitting part means a cable broadcasting station for transmitting a cable broadcast and the receiving part means a cable broadcasting receiver for receiving the able broadcast.

The cable broadcasting station is generally called a system operator (SO) head-end or a multiple system operator (MSO) head-end. The SO indicates a cable television service provider (i.e., a local cable TV broadcasting service provider). And, a group of a plurality of the SOs is called a multiple system operator (MSO).

A cable broadcast receiver is an open cable type that a point of deployment (POD) module including a conditional access system (CAS) is separated from a main body. The POD module is detachably loaded in a main body slot of a receiver and is able to use a cable card (CableCARD) of the specification such as personal computer memory card international association (PCMCIA). Hence, the POD module can be called a cable card.

The main body, in which the POD module is loaded, is generally called a host. And, the host can include a digital built-in television, a digital ready television or the like. The host and the POD module can be collectively called a cable broadcast receiver.

In the following description, a device capable of receiving a digital cable broadcast is named a host. And, a card loaded in the slot via a slot or the like to output a cable broadcast is named a cable card.

Meanwhile, the host receives and processes an OpenCable Application Platform (OCAP) based service provided by a head-end. In particular, the host downloads OCAP-J(ava) application such as a monitor application transmitted from a head-end located in a remote place via cable network, Electronic Program Guide (EPG) and the like and then drives the downloaded application on its system.

Currently, the OCAP based service in the early stage of service and such a service including basic methods only as EPG, Impulse Pay-Per-View (IPPV) and the like is provided. Yet, if environments of the OCAP based service are stabilized in the future, the number of various OCAP services provided by the head-end will be incremented.

As the number of OCAP based services provided by the head-end becomes incremented, a storage device for supporting the corresponding services will become more important. Therefore, it will be necessary to extend the concept of the storage device defined by the conventional OCAP specifications in the future.

### SUMMARY OF THE INVENTION

Accordingly, the present invention is directed to a host for data broadcast and a method of processing data for a data broadcast that substantially obviate one or more problems due to limitations and disadvantages of the related art.

An object of the present invention is to provide a host for data broadcast and a method of processing data for a data broadcast, by which channel variation and noise can be easily handled.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a host for data broadcasting includes a host controller configured to receive a request for searching a remote storage device connected to the host using a network from an application, control to call a method and detect the remote storage device in accordance with the received request, generate an event for returning a result of the detection according to the called method to the application, and return the generated event to the application.

Also, the host controller further receives a proxy in order to access the detected remote storage device from the application after forwarding the generated event to the application. Herein, the host controller further controls to access the detected remote storage device on the application according to the received proxy.

Also, the method is included a class of storage manager in a storage package. Herein, the class of storage manager includes an element for detecting the remote storage device connected to the host using the network.

Also, the remote storage device includes an accessible shared directory on the host using a function of sharing network.

Also, the host controller further controls to refresh the detected remote storage device.

In another aspect of the present invention, a method of processing data for a data broadcast includes receiving a request for searching a remote storage device connected to the host using a network from an application, calling a method in accordance with the received request, controlling to detect the remote storage device in accordance with the received request, generating an event for returning a result of the detection according to the called method to the application, and returning the generated event to the application.

Also, the method further comprises receiving a proxy to access the detected remote storage device from the application, and controlling to access the detected remote storage device on the application according to the received proxy. Herein, the method is included a class of storage manager in a storage package. And, the class of storage manager includes an element for detecting the remote storage device connected to the host using the network.

Also, the remote storage device includes an accessible shared directory on the host using a function of sharing network.

Also, the method further includes controlling to refresh the detected remote storage device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for an example of StorageManager class configured using a method according to the present invention;

FIG. 2 is a flowchart of an example for explaining a process for using the method defined in FIG. 1; and

FIG. 3 is a block diagram of a digital broadcast receiver according to one embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In the following description, first of all, OpenCable Application Platform (OCAP) is taken as an example for a data broadcasting platform. And, a cable broadcasting system is taken as an example for a broadcasting system for digital broadcasting.

Basically, the present invention relates to search, detect, and access to a detected storage device by a cable broadcast receiver (hereinafter called ‘host device’), and more particularly, to search, detect, and access to an accessible detected remote storage device including a network storage device connected to a host device using a network.

As mentioned in the foregoing description, as the OCAP based service environments are stabilized in the future, OCAP services provided by a head-end will become more diverse and the number of the OCAP services will be incremented.

Therefore, the host device should be equipped with sufficient storage devices for supporting the diverse and numerous OCAP based services provided by the head-end. Since a storage device within the host device is not enough to cover the provided services, it may be more efficient to utilize external storage devices.

Regarding the external storage devices, a user is able to physically add the storage device to the host device, e.g., a set-top box (STB), a set and the like. This is supported by the OCAP specifications in association with the present invention. For instance, a user is able to load such a storage device as a Universal Serial Bus (USB) memory, a flash memory card and the like via an interface existing in a STB or set. Hence, an OCAP-based host device is enabled to recognize the loaded storage device and then uses the recognized storage device in storing and using data.

Regarding the above description, the OCAP specifications define the contents related to a package called ‘org.ocap.storage’. The ‘org.ocap.storage’ package includes methods for ‘add, remove and manage’.

Therefore, using the ‘org.ocap.storage’ package relevant to a storage device within the OCAP specification, MiddleWare (M/W) within a host device is able to detect a storage device loaded by a user. The M/W is then able to forward the detected storage device to an application.

The present invention intends to extend the concept of the storage device in correspondence to the future increase of OCAP services. And, the OCAP specifications need to be amended to enable a host device to support the extended concept correspondingly. For instance, according to the conventional OCAP specifications, after M/W has detected a storage device connected to a host device, an application is allowed to access the detected storage device. In other words, the M/W becomes a subject to decide whether to perform the search.

Yet, it may happen that the M/W is unable to decide whether to perform the search. For instance, an application makes a request for a search for a connected storage device before the M/W performs the search. Hence, it is necessary to appropriately cope with such a case.

For clarity and convenience of the description of the technical idea of the present invention, a network storage device is taken as an example for a storage device. For instance, in case that the M/W of the host device is unable to determine a start point of a searching process for such a network storage device, the present invention intends to provide an apparatus for processing the case and method thereof.

In this disclosure, the concept for an external storage device defined in the OCAP specifications is extended to a network storage device and explicitly includes a searching process.

Accordingly, the M/W of the host device is able to search, detect, and/or refresh a currently available network storage device and an application may be able to access the detected network storage device via proxy.

In the following description, exemplarily explained is an example that a method for the searching function is included in ‘StorageManager’ class among five classes of the package.

First of all, the M/W searches and detects a currently available device and then generates a relevant event. This scheme enables a host device to search and detect an accessible sharing directory, i.e., a network storage device using a network sharing function.

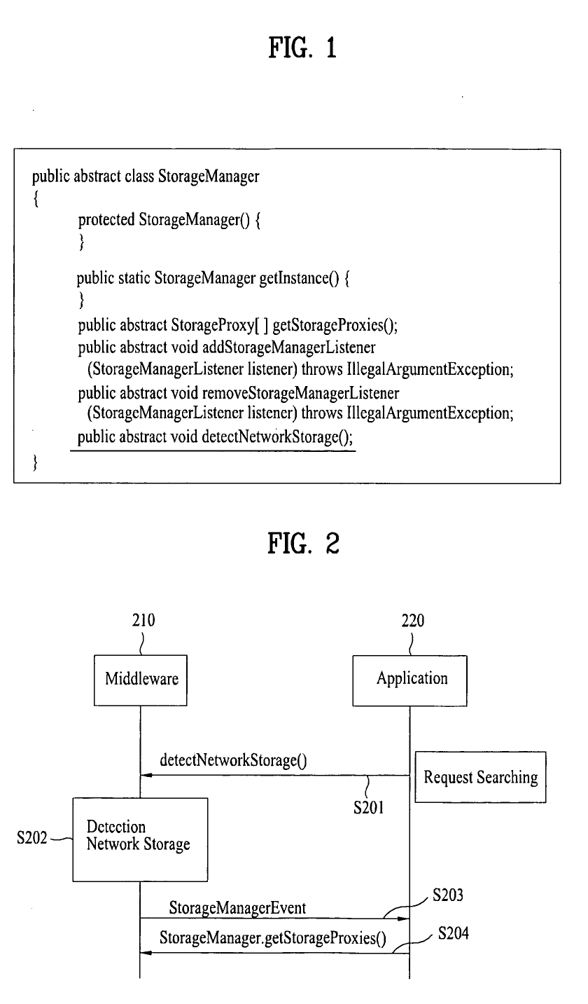

FIG. 1 is a diagram for an example of ‘StorageManager’ class configured using a method according to the present invention.

Regarding the present invention, various interfaces and a plurality of classes exist in the aforesaid ‘org.ocap.storage’ class. In this disclosure, exemplarily explained is a case that ‘StorageProxy’ interface and ‘StorageManager’ class are used.

The ‘StorageManager’ class is the class for indicating a storage manager for maintaining a track of a storage device connected to a system. The ‘StorageManager’ class includes constructors and methods for initialization of object data.

Referring to FIG. 1, the constructor is ‘protected StorageManager( )’ that means a protected default constructor. And, the methods include ‘getInstance( )’, ‘addStorageManagerListener(StorageManagerListener)’, ‘getStorageProxies’, ‘removeStorageManagerListener(StorageManagerListener)’ and ‘detectNetworkStorage( )’.

The ‘getinstance( )’ is the method for reading a singleton instance of a storage manager. The ‘addStorageManagerListener(StorageManagerListener)’ is the method of adding a listener to receive ‘StorageManagerEvent’ if a storage proxy is added or removed or if a status is changed.

The ‘getStorageProxies’ is the method for reading the setups of instants of ‘StorageProxy’ representing a currently connected or built-in storage device. The ‘removeStorageManagerListener(StorageManagerListener)’ is the method for removing a listener not to further receive ‘StorageManagerEvent’s when the storage proxies are changed.

The ‘detectNetworkStorage( )’ is the method for searching a network storage device. Regarding the present invention, for instance, if a network storage device search request is received from an application, it is able to be called the method.

As mentioned in the above description, the present invention takes an example for adding ‘detectNetworkStorage( )’ method to the ‘StorageManager’ class. The method searches and detects a currently available storage device and generates an event associated with returning the detected currently available storage device to the application. This scheme enables a remote storage device to search and detect an accessible sharing directory, i.e., a network storage device using a network sharing function.

In the following description, a process for using the method is explained. FIG. 2 is a flowchart of an example for explaining a process for using the method defined in FIG. 1, in which an application 220 includes extended application information table (Xlet) for clarity and convenience of description.

An Xlet application 220 makes a request for searching for a host-accessible network device to an M/W 210 to recognize which device is an accessible network storage device [S201].

In case of receiving the search request from the Xlet application 220, the M/W 210 searches and detects for an accessible network storage device connected to the host device [S202]. In performing the search and detect, the M/W 210 follows the ‘detectNetworkStorage( )’ method defined in FIG. 1.

If the accessible network storage device connected to the host device is detected, the M/W 210 returns a response to the search request to the application 220 [S203]. In this case, the return of the response generates an event (e.g., ‘StorageMAnageEvent’) according to the previously defined ‘detectNetworkStorage( )’ method.

In case of receiving the event (e.g., ‘StorageMAnageEvent’) from the M/W 210, the Xlet application 220 is able to recognize that there exists the network storage device accessible by the M/W 210. And, the Xlet application 220 is able to use the corresponding storage device.

Therefore, the Xlet application 220 is able to use the network storage device detected by the M/W 210 via the proxy (StorageManager.getStorageProxies( )).

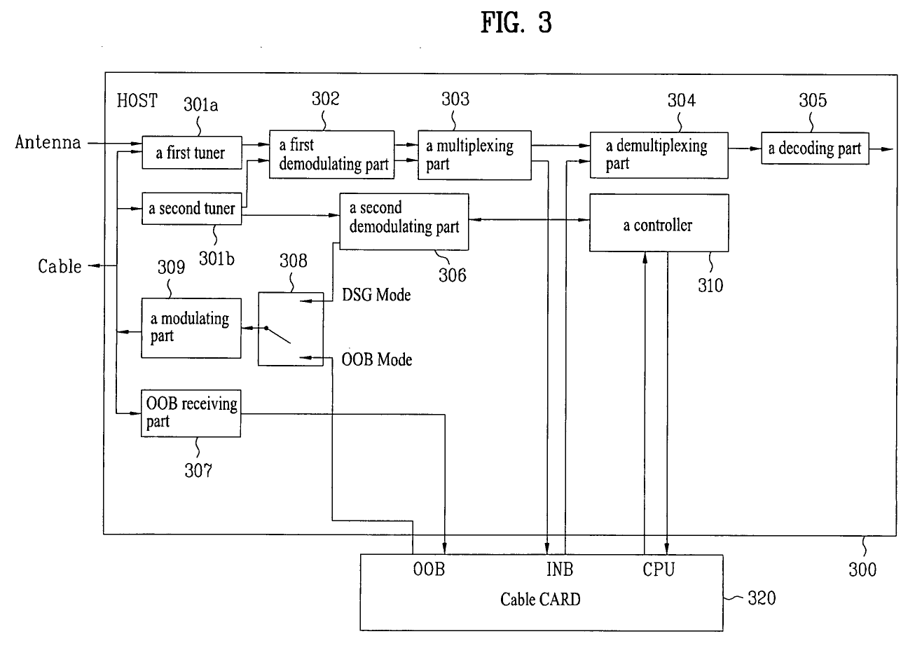

In the following description, an apparatus for enabling a connected network storage device to be searched, detected, and accessed according to the present invention is explained. FIG. 3 is a block diagram of a digital broadcast receiver according to one embodiment of the present invention. In the following description, a digital broadcast receiver according to the present invention includes a cable broadcast receiver for example.

Referring to FIG. 3, a cable broadcast receiver according to the present invention can include a host device and a communication device detachably provided to the host device. In this case, the communication device can include a cable card (CableCARD).

The host device is generally able to receive a cable broadcast signal only or at least one of a cable broadcast signal, a terrestrial broadcast signal and a satellite broadcast signal. Hence, the example shown in FIG. 3 considers a case that the host device is able to receive at least one broadcast signal of cable broadcasting, terrestrial broadcasting and satellite broadcasting.

Meanwhile, in the bi-directional (interactive) communication system between a cable broadcast receiver and a broadcasting station, there exist two kinds of systems. For open cable uplink services, Out Of Band (OOB) and Data-Over-Cable Service Interface Specification (DOCSIS) Set-top Gateway (DSG) are possible. Therefore, a viewer is able to select and view a specific program via a host device using either the OOB or the DSG. Alternatively, a viewer is able to directly join a broadcast program or can select to view necessary information. Moreover, a data broadcast service can be provided by both of the OOB and the DSG.

The OOB is the reference for specifying the transmission specifications between a cable broadcasting station and an inter-sec equipment within a set-top box (STB). On the contrary, the DSG indicates the transmission scheme between a cable model control system of a cable broadcasting station and a DOCSIS based cable modem within a set-top box. In this case, the DOCSIS can transport data using a cable modem.

The example shown in FIG. 3 represents a cable broadcast receiver adopting OOB & DSG hybrid scheme.

Referring to FIG. 3, a host device 300 can include a first tuner 301a, a second tuner 301b, a first demodulation part 302, a multiplexing part 303, a demultiplexing part 304, a decoding part 305, a second demodulation part 306 (DOCSIS), an OOB receiving part 307, a switching part 308, a modulation part 309, and a controller 310. And, a CableCARD 320 can be detachably loaded in the host device 300.

The first tuner 301a tunes to a specific channel frequency in the terrestrial Audio/Video (A/V) broadcast transmitted via antenna or the cable A/V broadcast transmitted on in-band via cable and then outputs it to the first demodulation part 302. In this case, the terrestrial broadcast can be transmitted by being modulated by Vestigial SideBand modulation (VSB) scheme. And, the cable broadcast can be transmitted by being modulated by Quadrature Amplitude Modulation (QAM) scheme.

Even if the terrestrial broadcast and the cable broadcast differ from each other in the transmission scheme, the first demodulation part 302 is able to perform demodulation according to each modulation scheme. Therefore, the first demodulation part 302 is able to demodulate a signal by VSB or QAM scheme according to the signal selected by the first tuner 301a.

Subsequently, the signal demodulated by the first demodulation part 302 is multiplexed by the multiplexing part 303. Hence, the cable broadcast can be outputted to the CableCARD 320 and the terrestrial broadcast can be outputted to the demultiplexing part 304.

The embodiment shown in FIG. 3 considers a case that the CableCARD 320 is able to process multi-streams. Hence, the CableCARD 320 enables a user to view a broadcast having at least two streams multiplexed via the host device 300.

The demultiplexing part 304 receives the multiplexed broadcast signal, demultiplexes the received broadcast signal into a plurality of streams, and then outputs the streams.

The decoding part 305 receives the broadcast signal demultiplexed by the demultiplexing part 304 and then decodes the received broadcast signal. The decoding part 305 decodes the demultiplexed broadcast signal and then outputs the decoded signal as A/V signal to be viewed by a user.

The second tuner 301b tunes to a specific channel frequency in the data broadcast transmitted via the cable by DSG and then outputs it to the second demodulation part 306. The second demodulation part 306 demodulates the DSG data broadcast and then outputs the demodulated broadcast signal to the controller 310.

The OOB receiving part 307 tunes to a specific channel frequency in the downlink data broadcast that is transmitted by OOB via the cable and then outputs it to the CableCARD 320.

In case that bi-directional (interactive) communications are possible between a cable broadcasting station and the cable broadcast receiver, uplink information transmitted to the cable broadcasting station from the cable broadcast receiver can be transmitted by OOB or DSG. Therefore, a cable broadcasting receiver according to one embodiment of the present invention can include the switching part 308 enabling information to be transmitted by selecting either OOB or DSG.

In the OOB scheme, user information or system diagnostic information is outputted to the modulation part 309 via the CableCARD 320 and the switching part 308. The modulation part 309 modulates the output signal by Quadrature Phase Shift Keying (QPSK) modulation or the like and then enables the modulated signal to be transmitted to the cable broadcasting station via the cable. If user's broadcast information is transmitted by DSG scheme, the information is outputted to the modulation part 309 via the controller 310 and the switching part 308, is signal-modulated by the modulation part 309 according to QAM-16 modulation or the like, and is then able to be transmitted to the cable broadcasting station via the cable.

In case that a terrestrial broadcast is received, the CableCARD 320 shown in FIG. 3 is able to receive a multi-stream broadcast signal from the multiplexing part 303. In this case, if the received broadcast signal is scrambled, the CableCARD 320 descrambles the scrambled broadcast signal to enable a user to normally view the cable broadcast.

The host device 300 of the present invention is able to include the controller 310 receiving a search request for an accessible storage device including a network storage device from an application and then returning the detected remote storage device to the application. In this case, the controller 310 can include a middleware (M/W).

Therefore, in performing the search and detect, the controller 310 follows the aforesaid ‘detectNetworkStorage( )’. In returning the detected one according to the method, the controller 310 is able to generate an event.

Moreover, the controller 310 is able to generate an event for returning the detected one to the application according to the pre-defined method. For instance, the event can include the aforesaid ‘StoreManagerEvent’.

In this disclosure so far, the scheme for enabling the part for the network storage device to be included in the storage device defined by OCAP has been explained. Hence, it is able to utilize the OCAP storage device specifications for the network storage device.

In the above description, for clarity and convenience of the description, OCAP is taken as an example.

By way of non-limiting examples, the present invention is applicable to various products that utilize external storage devices including the network storage device in T-commerce of Advanced Common Application Platform (ACAP) or Internet Protocol TeleVision (IPTV) for example.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A host for data broadcasting, the host comprising:
a host controller configured to receive a request for searching a remote storage device connected to the host using a network from an application, control to call a method and detect the remote storage device in accordance with the received request, generate an event for returning a result of the detection according to the called method to the application, and return the generated event to the application.

2. The host of claim 1, wherein the host controller further receives a proxy in order to access the detected remote storage device from the application after forwarding the generated event to the application.

3. The host of claim 2, wherein the host controller further controls to access the detected remote storage device on the application according to the received proxy.

4. The host of claim 1, wherein the method is included a class of storage manager in a storage package.

5. The host of claim 4, wherein the class of storage manager includes an element for detecting the remote storage device connected to the host using the network.

6. The host of claim 1, wherein the remote storage device includes an accessible shared directory on the host using a function of sharing network.

7. The host of claim 1, wherein the host controller further controls to refresh the detected remote storage device.

8. A method of processing data for a data broadcast, the method comprising:
receiving a request for searching a remote storage device connected to the host using a network from an application;
calling a method in accordance with the received request;
controlling to detect the remote storage device in accordance with the received request;
generating an event for returning a result of the detection according to the called method to the application; and
returning the generated event to the application.

9. The method of claim 8 further comprising:
receiving a proxy to access the detected remote storage device from the application;
controlling to access the detected remote storage device on the application according to the received proxy.

10. The method of claim 9, wherein the method is included a class of storage manager in a storage package.

11. The method of claim 10, wherein the class of storage manager includes an element for detecting the remote storage device connected to the host using the network.

12. The method of claim 8, wherein the remote storage device includes an accessible shared directory on the host using a function of sharing network.

13. The method of claim 8 further comprising:
controlling to refresh the detected remote storage device.
